(19) United States
(12) Patent Application Publication
(10) Pub. No.: US 2025/0266255 A1
(43) Pub. Date: Aug. 21, 2025

(54) Ion Source

(71) Applicant: SHIMADZU CORPORATION, Kyoto-shi (JP)

(72) Inventor: Kei KODERA, Kyoto-shi (JP)

(21) Appl. No.: 19/006,759

(22) Filed: Dec. 31, 2024

(30) Foreign Application Priority Data
Feb. 21, 2024 (JP) 2024-024398

(51) Int. Cl. H01J 49/12

(52) U.S. Cl. CPC H01J 49/12

(57) ABSTRACT

In an ion source 100 configured to generate ions by a process involving an electric discharge, at least the surface of at least an anode 121 of discharging electrodes included in the ion source is made of titanium in order to prevent a decrease in the power output of the ion source due to the formation of an oxide film on an electrode surface. Titanium has the nature that it forms a film on its surface through oxidization and yet does not lose its electric conductivity even when oxidized. Therefore, the power output of this ion source will not decrease even when an oxide film is formed on the surface of the anode, so that it can be used for a long period of time without requiring the electrode polishing or similar tasks.

### TECHNICAL FIELD

The present invention relates to an ion source.

### BACKGROUND ART

As an ionization method in a mass spectrometer or similar devices, an “ionization by a proton transfer reaction”, which is a kind of chemical ionization (CI), has been commonly known. In the ionization by a proton transfer reaction (which is hereinafter called the “PTR ionization”), plasma is initially generated by inducing an electric discharge within a cloud of steam in a predetermined space (primary ion source), and H₃O⁺ ions (hydronium ions) contained in the plasma are drawn from that space into another space (secondary ion source) and made to react with gaseous target molecules, whereby H⁺ (proton) is transferred from the ions to the target molecules to ionize the target molecules. PTR ionization can ionize any substance which has a higher degree of proton affinity than the H₃O⁺ ion. Therefore, this technique has the characteristic of being capable of ionizing most of the volatile organic compounds (VOC) except for low-molecular alkanes (e.g., methane) while avoiding the ionization of nitrogen, oxygen, carbon dioxide, nitrous oxide and other substances contained in the atmosphere. In recent years, due to this characteristic, mass spectrometers having an ion source which performs PTR ionization in the previously described manner (“PTR ionization mass spectrometer”) have been widely used for VOC analysis (for example, see Non Patent Literature 1).

In an ion source configured to perform PTR ionization in the previously described manner (which is hereinafter called the “PTR ion source”), it is often the case that an electrode made of stainless steel (Non Patent Literature 2) or aluminum is used as the electrode for the electric discharge. Patent Literature 1 discloses a PTR ion source having an electrode made of molybdenum. However, since molybdenum is expensive and difficult to process, this material has not been generally used for electrodes in a PTR ion source.

### CITATION LIST

### Patent Literature

Patent Literature 1: U.S. Pat. No. 6,037,587 A

### Non Patent Literature

Non Patent Literature 1: Akira Tani, “Kihatsusei Yuuki Kagoubutsu No Shinki Kousoku Bunsekihou—Youshi Idou Hannou shitsuryou Bunsekikei—(Novel method for rapid analysis of volatile organic compounds—Proton Transfer Reaction Mass Spectrometer —)”, Journal of Japan Society for Atmospheric Environment, Vol. 38, No. 4, 2003, p. A35-A46
Non Patent Literature 2: Satoshi Inomata, et. al., “A novel discharge source of hydronium ions for proton transfer reaction ionization: design, characterization, and performance”, Rapid Commun Mass Spectrom., Volume 20, Issue 6, 2006, p. 1025-1029, doi: 10.1002/rcm.2405

### SUMMARY OF INVENTION

### Technical Problem

However, the plasma generated in a PTR ion source contains not only the H₃O⁺ ion but also various ions and radicals (O⁺, OH⁺) as well as oxygen atoms. Those ions and other particles oxidize the discharging electrode (particularly, the anode) provided in the PTR ion source, whereby an oxide film is formed on the surface of the electrode. In a conventional and common type of PTR ion source, the formation of this oxide film causes a gradual decrease in the power output and ultimately prevents the electric discharge from occurring. Therefore, it is necessary to remove the oxide film by a maintenance task, such as the electrode polishing, or to replace the electrode.

The present invention has been developed in view of the previously described point. Its objective is to prevent a decrease in the power output due to the formation of an oxide film on an electrode surface in an ion source configured to generate ions by a process involving an electric discharge.

### Solution to Problem

An ion source according to the present invention developed for solving the previously described problem is an ion source having discharging electrodes and configured to generate ions by a process involving an electric discharge between the discharging electrodes, where the surface of an anode of the discharging electrodes is made of titanium.

### Advantageous Effects of Invention

The ion source according to the present invention having the previously described configuration can prevent a decrease in the power output due to the formation of an oxide film on an electrode surface in an ion source configured to generate ions by a process involving an electric discharge.

### BRIEF DESCRIPTION OF DRAWINGS

FIG. 1 is a configuration diagram of the main components of a PTR ionization mass spectrometer according to one embodiment of the present invention.

FIG. 2 is a model diagram showing the configuration of the main components of the ion source in the aforementioned embodiment.

FIG. 3 is a graph showing a temporal change of a total ion current (TIC) in a present example as well as a comparative example.

### DESCRIPTION OF EMBODIMENTS

A mode for carrying out the present invention is hereinafter described with reference to the drawings.

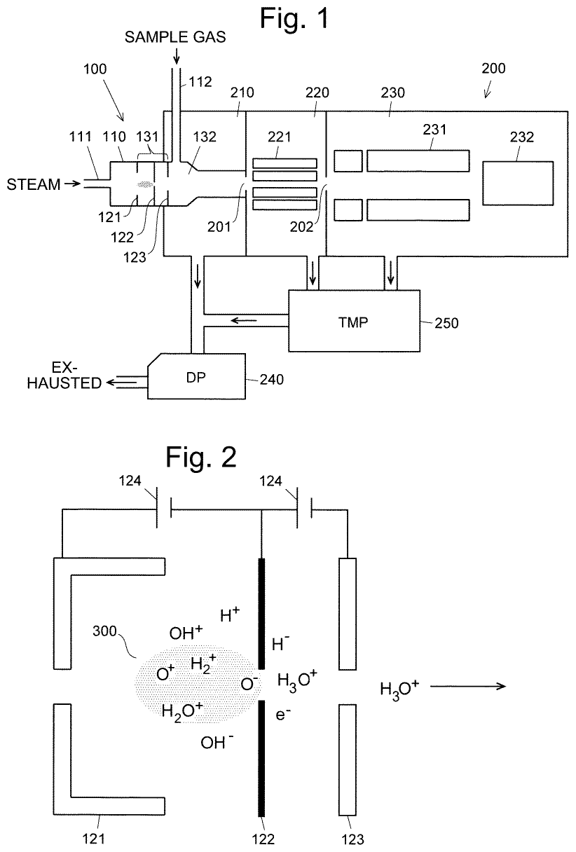

The mass spectrometer according to the present embodiment is a PTR ionization mass spectrometer (PTR-MS) including an ion source 100 configured to generate ions from a gaseous sample (sample gas) by means of a proton transfer reaction and an analyzing section 200 configured to detect the generated ions after performing the mass separation of those ions. FIG. 1 is a model diagram showing a schematic configuration of the mass spectrometer according to the present embodiment. FIG. 2 is a model diagram showing the configuration of the main components of the ion source 100.

The ion source 100 includes a substantially cylindrical ion source chamber 110, an anode 121, extracting electrode 122 and cathode 123 arranged within the ion source chamber 110, as well as a power source 124 (which is omitted in FIG. 1) configured to apply predetermined voltages to those electrodes 121, 122 and 123. The anode 121, extracting electrode 122 and cathode 123 are arranged in this order from one end (entrance end) to the other end (exit end) of the ion source 100. The anode 121 and the cathode 123 function as discharging electrodes for generating plasma within the ion source chamber 110. The extracting electrode 122 has the function of creating a potential gradient from the anode 121 so that a predetermined kind of ion (H₃O⁺ ion) included in the various ions generated by the plasma will be guided to a secondary ion source 132 (which will be described later) by the potential gradient. The extracting electrode 122 in FIG. 2 is a plate electrode having an orifice (aperture) for allowing ions to pass through, although the shape of the extracting electrode 122 is not limited to this example. The anode 121 in FIG. 2 is a cup-shaped electrode having an orifice (aperture) for allowing steam to pass through on the bottom side (the left side in FIG. 2), although the anode 121 is not limited to this shape; for example, it may have a needle-like shape. The space between the anode 121 and the cathode 123 within the ion source chamber 110 functions as a primary ion source 131 for generating H₃O⁺ ions from steam. The space between the cathode 123 and the exit end of the ion source chamber 110 functions as a secondary ion source 132 for generating ions from a sample by a reaction between the H₃O⁺ ions and a sample gas. A steam-introducing unit 111 for introducing, into the ion source chamber 110, the steam to be sent to the primary ion source 131 (this steam corresponds to the source gas in the present invention) is provided at the entrance end of the ion source chamber 110. A sample-gas introducing unit 112 for introducing a sample gas into the secondary ion source 132 is provided in the circumferential wall of the ion source chamber 110.

In the ion source 100 according to the present embodiment, at least the surface of the anode 121 is made of titanium. The anode 121 may consist of an electrode body made of stainless steel, aluminum or similar material with a titanium film formed by a plating or coating process, or alternatively, it may be an electrode entirely made of titanium. A titanium alloy (e.g., with aluminum, nickel or similar element added to titanium) may also be used as the aforementioned titanium, although it is preferable to use pure titanium from the viewpoint of the workability. A product of pure titanium for industrial application belonging to any one of the four types of JIS Classes 1 through 4 may be used as pure titanium, of which a product of JIS Class 1 or 2 having a particularly high degree of purity should preferably be used. In the case of using a titanium alloy, it is preferable to use a product with a titanium content equal to or higher than 95% by weight (and more preferably, 99% by weight). As for the extracting electrode 122 and the cathode 123, any material may be used, although it is preferable that at least their surface be made of titanium, as with the anode 121.

The analyzing section 200 includes a first vacuum chamber 210, second vacuum chamber 220 and third vacuum chamber 230 sequentially arranged from the ion source chamber 110, having the configuration of a multi-stage differential pumping system with their degrees of vacuum gradually increased in the aforementioned order. The first vacuum chamber 210 is evacuated with a dry vacuum pump (DP) 240. The second and third vacuum chambers 220 and 230 are individually evacuated with a turbo-molecular pump (TMP) 250 combined with the dry vacuum pump 240 serving as a roughing vacuum pump. Although the present embodiment assumes that the analyzing section 200 consists of three vacuum chambers, the number of compartments in the evacuated section may be changed as needed. The ion source chamber 110 communicates with the second vacuum chamber 220 through an extremely small ion passage hole 201, while the second vacuum chamber 220 communicates with the third vacuum chamber 230 through a likewise small ion passage hole 202. An octapole ion transport unit 221 is located within the second vacuum chamber 220. A mass separation unit 231 consisting of a quadrupole mass filter and a detector 232 for detecting ions are located within the third vacuum chamber 230. Although the ion transport unit 221 in the present embodiment is formed by an octapole, the configuration of the ion transport unit 221 is not limited to this example. Additionally, although the mass separation unit 231 in the present embodiment consists of a quadrupole mass filter, the configuration of the mass separation unit 231 is not limited to this example.

In the circumferential wall of the ion source chamber 110, an opening (not shown) for allowing the ion source chamber 110 to communicate with the first vacuum chamber 210 is provided. This opening provides a passage for evacuating the inner space of the secondary ion source 132 as well as discharging neutral particles and unnecessary ions from the primary ion source 131 to the outside.

An operation for analyzing a sample by the mass spectrometer according to the present embodiment is hereinafter described. Initially, the dry vacuum pump 240 and the turbo-molecular pump 250 are energized to evacuate the ion source chamber 110, first vacuum chamber 210, second vacuum chamber 220 and third vacuum chamber 230 to their respectively predetermined degrees of vacuum. Subsequently, steam is introduced from the steam-introducing unit 111 into the ion source chamber 110. Then, a predetermined voltage is applied between the anode 121 and the cathode 123 to generate an electric discharge between the two electrodes 121 and 123, whereby a cloud of steam plasma 300 is generated within the primary ion source 131. The steam plasma 300 contains various ions, among which the predetermined kinds of ions including the H₃O⁺ ion are extracted from the steam plasma 300 by the extracting electrode 122 and sent to the secondary ion source 132. Furthermore, a sample gas is introduced into the secondary ion source 132 via the sample-gas introducing unit 112. The H₃O⁺ ions (which correspond to the primary ion in the present invention) sent to the secondary ion source 132 are accelerated by a potential gradient created within the secondary ion source 132 by the electrodes and the power source (which are not shown) and collide with the molecules of the various components contained in the sample gas (sample components). If the sample component involved in the collision has a higher degree of proton affinity than the H₃O⁺ ion, a proton transfer reaction occurs through the collision, whereby the sample component is ionized. Examples of the molecules of the sample components are volatile organic carbon compounds exclusive of lower alkanes (C≤5), such as methane. More specific examples are formaldehyde, acetaldehyde, methanol, ethanol, dimethyl ether, benzene, toluene, ethylbenzene, isoprene, methyl iodide, ethyl iodide, ethyl chloride, monoterpene, isoprene and acetone. The ions generated from sample components (these ions correspond to the secondary ion in the present invention) are introduced into the second vacuum chamber 220 due to the pressure difference within the device and further transported to the third vacuum chamber 230 while being converged by the ion transport unit 221 within the second vacuum chamber 220. Within the third vacuum chamber 230, the ions are separated from each other according to their masses (or more exactly, their m/z) by the mass separation unit 231 and detected by the detector 232.

As noted earlier, conventional and common types of PTR-MSs have the problem that, as the device is used, an insulation layer consisting of an oxide film is formed on the electrode in the ion source, causing a decrease in the power output of the ion source. This problem is particularly noticeable on the anode of the discharging electrodes for generating an electric discharge within the ion source. This is most likely due to oxygen-related negative ions resulting from the electric discharge and colliding with the anode. As described previously, in the mass spectrometer according to the present embodiment, at least the surface of at least the anode 121 among the electrodes included in the ion source 100 is made of titanium. Titanium has the nature that it forms a film on its surface through oxidization and yet does not lose its electric conductivity even when oxidized. The resistivity of titanium oxide is from 10³Ω·m to 10⁴Ω·m, which is a sufficiently low value for an electrode used in the ion source 100. From the fact described thus far, the ion source 100 and the mass spectrometer according to the present embodiment can be used for a long period of time without requiring the electrode polishing or similar tasks since the power output of the ion source 100 will not decrease even when an oxide film is formed on the surface of the anode 121. Furthermore, the ion source 100 and the mass spectrometer according to the present embodiment can be realized without a dramatic increase in production cost since titanium is comparatively inexpensive and the workability of pure titanium is comparable to that of stainless steel. The non-magnetic nature of titanium is also suited for an electrode material in the ion source 100. The anode 121 in the present embodiment may have the oxide film formed beforehand. In the case where one or both of the cathode 123 and extracting electrode 122 are also made of titanium, the oxide film may be similarly formed beforehand on the surface of the electrode or electrodes concerned.

A description of one mode for carrying out the present invention has been given so far using specific examples. It should be noted that the present invention is not limited to the previous embodiment; any appropriate change or modification is allowed within the spirit of the present invention. For example, although the previous embodiment was an example in which the present invention was applied in a PTR ion source, the present invention is not limited to this example but may be applied in any type of ion source configured to generate ions by a process involving an electric discharge. As a specific example, the present invention may be applied in an ion source configured to ionize a sample by an chemical ionization method different from the PTR ionization, as long as the ion source has a primary ion source configured to generate a primary ion (reagent ion) from a source gas (e.g., steam or air) by a process involving an electric discharge generated by discharging electrodes and a secondary ion source configured to generate a secondary ion (sample-molecule ion) which is an ion of a sample component by causing the primary ion to react with the sample component. An example of this type of ion source is an ion source used in a multiple reaction real-time mass analyzer (also called a “Selected Ion Flow Tube Mass Spectrometer” or “SIFT-MS”) configured to generate a primary ion (H₃O⁺, NO+, O₂⁺, O⁻, O₂⁻, OH⁻, NO₂⁻, NO₃⁻ or the like) from air by an electric discharge and then ionize a sample molecule by an ion-molecule reaction with the primary ion. The ion source according to the present invention is also applicable in a device other than mass spectrometers; for example, it may be applied in an ion mobility analyzer in which ions originating from a sample component are detected after being separated from each other according to their ion mobilities, or an ion mobility-mass spectrometer in which ions generated from a sample component are initially separated from each other according to their ion mobilities and further separated from each other according to their mass-to-charge ratios.

### EXAMPLE

In a PTR-MS having the same configuration as shown in FIG. 1, a temporal change of a total ion current (TIC) in a measurement of a sample was monitored in the case where an anode made of titanium (pure titanium of JIS Class 2; present example) was used in the discharging electrode included in the ion source as well as in the case where an anode made of stainless steel (SUS 316; comparative example) was used. The other electrodes (i.e., the cathode and the extracting electrode in the discharging electrode) included in the PTR ion source were made of stainless steel (SUS 316) in both of the present and comparative examples. Additionally, in both of the present and comparative examples, the flow velocity of the steam introduced into the PTR ion source was 5 sccm, that of the sample gas introduced into the same ion source was 15 sccm, and the used sample gas had the same composition. The discharge current in the ion source was controlled to be equal to or less than 2 mA. The pressure within the secondary ion source was controlled to be equal to or less than 200 Pa.

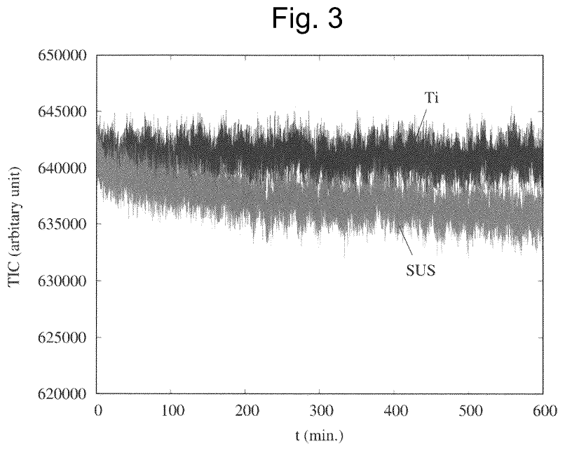

FIG. 3 shows the temporal change of the TIC in the present and comparative examples. “Ti” in FIG. 3 shows the measured result of the present example, while “SUS” shows that of the comparative example. As shown in the graph, although short cycle fluctuations were observed in the TIC in both present and comparative examples, it was confirmed that the TIC in the present example was generally maintained at constant levels for 600 minutes (10 hours) while the TIC in the comparative example gradually decreased with the passage of time.

### [Modes]

It is evident to a person skilled in the art that the previously described illustrative embodiments are specific examples of the following modes of the present invention.

(Clause 1) An ion source according to one mode of the present invention is an ion source having discharging electrodes and configured to generate ions by a process involving an electric discharge between the discharging electrodes, where the surface of an anode of the discharging electrode is made of titanium.

(Clause 2) In an ion source according to Clause 2, which is one mode of the ion source according to Clause 1, the titanium is pure titanium.

(Clause 3) An ion source according to Clause 3, which is one mode of the ion source according to Clause 1 or 2, further includes:
a primary ion source including the discharging electrodes and configured to generate a primary ion from a source gas by a process involving an electric discharge between the discharging electrodes; and
a secondary ion source configured to generate a secondary ion which is an ion of a sample molecule by a reaction between the primary ion and the sample molecule.

(Clause 4) In an ion source according to Clause 4, which is one mode of the ion source according to one of Clauses 1-3, the ion source is configured to generate ions by a proton transfer reaction.

(Clause 5) A mass spectrometer according to Clause 5 is a mass spectrometer having the ion source according to one of Clauses 1-4.

### REFERENCE SIGNS LIST

100 . . . Ion Source
110 . . . Chamber
121 . . . Anode
122 . . . Extracting Electrode
123 . . . Cathode
200 . . . Analyzing Section
300 . . . Steam Plasma

1. An ion source having discharging electrodes and configured to generate ions by a process involving an electric discharge between the discharging electrodes, wherein a surface of an anode of the discharging electrodes is made of titanium.

2. The ion source according to claim 1, wherein the titanium is pure titanium.

3. The ion source according to claim 1, further comprising:
a primary ion source including the discharging electrodes and configured to generate a primary ion from a source gas by a process involving an electric discharge between the discharging electrodes; and
a secondary ion source configured to generate a secondary ion which is an ion of a sample molecule by a reaction between the primary ion and the sample molecule.

4. The ion source according to claim 1, wherein the ion source is configured to generate ions by a proton transfer reaction.

5. A mass spectrometer, comprising the ion source according to claim 1.
